(19) United States
(12) Patent Application Publication
(10) Pub. No.: US 2026/0227762 A1
(43) Pub. Date: Aug. 6, 2026

(54) SYNCHRONISATION METHOD FOR THE COORDINATED EXECUTION OF WORKING STEPS FOR A PROCESSING OF A WORKPIECE

(71) Applicant: Siemens Aktiengesellschaft, 80333 München (DE)

(72) Inventors: PETER BAUER, Herzogenaurach (DE); KLAUS GEISSDÖRFER, Erlangen (DE); FLORIAN LORENZ, Passau (DE); THOMAS PUCHTLER, Adelsdorf (DE); SVEN TAUCHMANN, Chemnitz (DE)

(73) Assignee: Siemens Aktiengesellschaft, 80333 München (DE)

(21) Appl. No.: 19/149,496

(22) PCT Filed: Dec. 19, 2023
(86) PCT No.: PCT/EP2023/086556

§ 371 Date: Jul. 18, 2025

(30) Foreign Application Priority Data
Jan. 19, 2023 (EP) 23152420.8

(51) Int. Cl. G05B 19/4155; B25J 11/00

(52) U.S. Cl. CPC G05B 19/4155; B25J 11/005; G05B 2219/50216

(57) ABSTRACT

A synchronization method for coordinated execution of working steps for processing a workpiece includes executing with a first processing apparatus of a processing machine a first working step having a first synchronization parameter, executing with a second processing apparatus of the processing machine or of another processing machine a second synchronization parameter, wherein the first and second synchronization parameters are based on a processing parameter for processing the workpiece. The first synchronization parameter is continuously compared with the second synchronization parameter, and a coordinated execution of the first and second working step is performed according to the result of the comparison. Also described are a processing machine and a processing machine system employing the synchronization method, and a computer program product for at least partially carrying out the synchronization method.

The invention relates to a synchronization method for the coordinated execution of working steps for processing a workpiece, wherein a first processing apparatus of a processing machine executes a first working step and a second processing apparatus of the processing machine or of a further processing machine executes a second working step. The invention further relates to a processing machine and a processing machine system having the synchronization method and also to a computer program product for at least partially executing the synchronization method.

In the processing of workpieces—as well as in the production of products—it is often necessary for processing or production steps, which are performed, for example, by a machine tool for processing a workpiece or by a production machine for producing a product, to take place in each case synchronously with one another.

A synchronized sequence of these working steps supports the coordination of processing or manufacturing processes for the processing of workpieces or the production of products. The coordination of the working steps prevents processing apparatuses for the processing of the workpieces or production units for the production of the products from mutually impeding one another, for example in the case of parallel working steps, or from remaining in a waiting position for an unnecessarily long time in the case of serial working steps, until the next working step of the processing or production takes place.

Since corresponding requirements and the associated problems are the same both for the processing of workpieces by means of machine tools and for the production of products by means of production machines—robots can also be used here In each case—the further considerations in the aforementioned context will focus on the processing of workpieces, wherein this includes the production of products.

In this context, the production of the product is to be understood analogously to the processing of the workpiece.

In conjunction with the processing of a workpiece, it is usually the case that at least one processing apparatus that is processing the workpiece executes a movement in one of its working steps and/or the workpiece to be processed moves or is moved during the working step.

An example of the processing of the workpiece is that a first processing apparatus configures the workpiece by means of a movable milling tool, wherein a second processing apparatus sucks away the milled chips by means of a movable or fixed suction apparatus.

A coordinated processing of the workpiece by means of the two processing apparatuses is accordingly a requirement which makes it necessary to synchronize the corresponding working steps of the respective processing apparatuses with one another.

In this context, synchronization can mean, on the one hand, that the working step of sucking away the milled chips by means of the second processing apparatus is performed at least partially parallel to the working step of the milling process by means of the first processing machine.

For this example, the challenge in the processing of the workpiece is usually that both processing apparatuses do not hinder each other, as already mentioned, which could lead to damage or destruction of the processing apparatuses or the workpiece.

In this context, synchronized can, on the other hand, also mean that the working step of milling the workpiece by means of the first processing apparatus has already been completed before the milled chips are sucked away by means of the suction apparatus. In this example, the challenge in the processing of the workpiece is often in the foreground that the working step of the milling procedure on the workpiece transitions as quickly as possible into the working step of sucking away the milled chips on the workpiece.

Furthermore, for the coordinated processing of the workpiece—and the associated synchronization requirements—it must be taken into account whether or not identical conditions prevail, such as, for example, with the same movement guidance of at least two processing apparatuses using the same processing apparatuses—comprising the same tools used for processing the workpiece—with separate processing spaces in each case or not.

If there is a rather less complex case of predominantly identical conditions, two identical working steps can be performed at least partially in parallel, in particular with a view to the same movement guidance of the processing apparatuses in different processing spaces.

In the case of identical working steps, for example, clock-synchronous desired values can be predefined by an open loop or closed loop control unit for each of the two processing apparatuses, and it is thus possible to perform the synchronous processing of the respective working steps.

Often, however, non-identical conditions for coordination with an increased synchronization effort of the working steps of the processing apparatuses for the processing of the workpiece are to be expected. This relates, on the one hand, to the use of different processing apparatuses—with partially different tools—and, on the other hand, to overlapping processing spaces for the mostly moving processing apparatuses, so that different desired values must be provided for the participating processing apparatuses.

In this context, the term synchronous and its offshoots, such as synchronism or synchronization, are also eligible, since in this context it is a question of mutually temporally coordinated procedures of processing working steps for the various processing apparatuses, which does not necessarily have to take place in parallel, but can also take place in series.

A sole use of clock-synchronous desired values in the execution of the corresponding working steps for the respective processing apparatuses is also not sufficient for a coordinated processing of the workpiece due to the usually expected—possibly also only small—different spatial and mechanical conditions with resulting different distances—and this even with the same or approximately the same working steps.

For example, a comparison variable suitable per se for the synchronization of the working steps of the participating processing apparatuses, such as, for example, a path length to be traveled as a corresponding reference parameter in a machine tool with the same processing start of the participating processing apparatuses, can appear quite suitable for the synchronization under ideal conditions that are often only theoretically obtainable.

In practice, such ideal conditions are often not achievable, which generally leads to undesired deviations of the predetermined processing patterns of the participating processing apparatuses with regard to the path traveled and/or the time that is required during the processing of the workpiece, and can possibly cause the participating processing apparatuses to drift against one another.

As a result, for example, contour damage of the workpiece—triggered, for example, by undesired collisions of the processing apparatuses with the workpiece—or collisions of the processing apparatuses with one another must be expected.

Even though it is possible for the drifting of the processing apparatuses against one another to be reduced by implementing different block cycle times for the control of the working steps of the processing apparatuses, a filling of a forward-looking buffer for a forward movement or an introduction of a so-called accuracy window due to a systematically or stochastically different encoder detection in the case of rotational movements. Such implementations however generally result in a limitation of the dynamics of the movable processing apparatuses or a movable workpiece apparatus.

Furthermore, by means of so-called waiting marks—for example implemented in the control of a machine tool or a production machine—an at least selective synchronization of the working steps of the respective processing apparatuses can take place. This approach, however, does not allow any statement regarding the status of the synchronization between the waiting marks and thus also regarding the coordinated sequence of the working steps for the respective processing apparatuses. Therefore, when the waiting marks are used, an undesired drifting of the processing apparatuses against one another can also occur. In addition, a partially hard or abrupt synchronization of the participating processing apparatuses and/or the workpiece apparatus takes place only at the waiting marks.

In addition to the negative consequences for a mechanical integrity of the processing apparatuses and/or the workpiece apparatus, impairments of the processing quality of the workplece can therefore also be expected.

The invention is based on the object of proposing a synchronization method that is improved over the prior art for the coordinated execution of working steps for processing a workpiece and also a processing machine and a processing machine system having the synchronization method and also a computer program product for at least partially executing the synchronization method.

The object is achieved by a synchronization method having the features disclosed in claim 1, a processing machine having the synchronization method according to the features disclosed in claim 13, a processing machine system having the synchronization method according to the features disclosed in claim 14, and a computer program product for at least partially executing the synchronization method in accordance with the features disclosed in claim 15.

In order to achieve the object, a synchronization method for the coordinated execution of working steps for processing a workpiece is proposed, wherein a first processing apparatus of a processing machine executes a first working step, wherein a second processing apparatus of the processing machine or of a further processing machine executes a second working step, wherein the first working step has a first synchronization parameter and the second working step has a second synchronization parameter, wherein the first and second synchronization parameters are based on a processing parameter for processing the workpiece, wherein in a comparison the first synchronization parameter is continuously compared with the second synchronization parameter and wherein the coordinated execution of the first and second working step is performed in dependence upon the result of the comparison.

With the introduction of the first and second synchronization parameters into the corresponding working steps of the respective processing apparatuses of the at least one processing machine, a direct and continuous synchronization reference to the processing parameter, which, introduced as the leading variable for the processing of the workpiece, is now produced for the synchronization and as a result for the coordinated execution of the working steps.

This processing parameter can have both technological process properties for processing the workpiece—for example a superordinate sequence of the working steps—and technical properties—for example the path length to be traveled of a processing path of the machine tool for processing the workpiece in the form of a manipulated variable for the one feed of the workpiece or the tools of the processing apparatuses.

The synchronization parameters that are based on the processing parameter for the corresponding working steps of the respective processing apparatuses are continuously compared with one another, so that, depending on the result of the comparison, the affected working steps with regard to their processing activities are adapted to the comparison situation or are continued without adaptation with a view to the synchronization.

By means of the continuously progressive synchronization at least during the execution of the working steps, the coordinated sequence of these working steps for the respective processing apparatuses is advantageously generated, which allows the processing process of the processing of the workpiece to be further optimized in comparison with known solutions.

The risk of the processing apparatuses drifting against one another or working against one another, with the possible consequence of damage or destruction of the processing apparatuses (comprising the tool and/or the workpiece), can therefore be avoided or at least further reduced—even while shortening or at least maintaining the processing times of the workpiece that are necessary compared to known synchronization or processing methods.

Advantageous embodiments of the synchronization method are disclosed in the dependent claims.

In a first advantageous embodiment of the synchronization method, the first synchronization parameter of the first working step is based on the processing parameter that is configured as a processing desired value.

The processing desired value for the processing of the workpiece is generally formed in or output by a control unit, wherein the control unit is preferably comprised by the processing machine. However, one or all of the processing apparatuses can also have such a control unit.

The processing desired value is the technically and/or technologically influenced processing parameter that is provided for processing the workpiece, such as, for example, a manipulated variable of the path to be traveled for the feed of the tool and/or the workpiece on the machine tool.

A device topology for implementing the synchronization method—as well as generally for processing the workpiece—Is often configured in such a way that all participating processing apparatuses with their corresponding tools—as well as a tool apparatus for fixing and/or moving the workpiece—are arranged in the processing machine.

If, however, the processing apparatuses are distributed to different processing machines, a data exchange between the two processing machines can be provided by means of a communication unit in order to transmit the processing parameter—here as a processing desired value, which was generated, for example, by means of a control of a control unit in at least one of the processing machines between the processing machines.

In a further advantageous embodiment of the synchronization method, the second synchronization parameter of the second working step is based on a processing parameter that is configured as a simulation desired value for the processing desired value or on a processing parameter that is configured as a dependent processing desired value for the processing desired value.

If the second synchronization parameter is based on the simulation desired value of the processing parameter that is configured as a processing desired value, the data exchange between the two processing machines and/or the two processing apparatuses at least does not have to take place permanently, which offers potential savings both from the point of view of the communication apparatus and from the point of view of a data volume that is required for the data exchange and limits the complexity of the synchronization method,

In the case that the dependent processing desired value is provided for the processing parameter that is configured as a processing desired value, a data exchange system known as a master-slave model can be used, wherein the primary replica model is used here in the following as a linguistic alternative (master->primary; slave->replica), which completely replaces the above master-slave model in terms of content.

This primary replica model is designed in such a way that the dependent processing desired value as a replica portion follows the processing desired value as a primary portion of the model.

In a further advantageous embodiment of the synchronization method, the simulation desired value is determined during the execution of the second working step.

Under these conditions, the use of the simulation desired value renders it possible for the second synchronization parameter, which is based on the processing desired value, to be reproduced during the processing of the workpiece in the second working step, independently of the continuous knowledge of the processing desired value as a real predetermined processing variable, so that the second processing apparatus is advantageously operated essentially independently during the course of the second working step.

In a further advantageous embodiment of the synchronization method, in the event of an inequality of the synchronization parameters that is determined as a result of the comparison, a processing change is performed in at least one of the working steps for their respectively allocated processing apparatuses.

An inequality of the synchronization parameters therefore has the consequence that the processing change advantageously specifies spatial and/or temporal processing requirements with both technical and procedural character for the working steps of the corresponding processing apparatuses, which as a result produces the required synchronism for the coordinated execution of the working steps for the processing of the workpiece.

On the one hand, both working steps of the corresponding processing apparatuses can be affected by this processing change—up to the production of synchronism—and, on the other hand, only one of the working steps can be affected.

In a further advantageous embodiment of the synchronization method, in the case that the first processing apparatus is configured as a first tool apparatus having a first tool, in the event of inequality of the synchronization parameters a first processing speed or derivatives thereof, by means of which the first tool processes the workpiece, is changed as a processing change.

Any change in the speed for processing the workpiece is assumed as a processing change of the first processing speed, which in this case relates to the first processing speed for the first tool—for example a first welding head—and is executed by means of the first tool apparatus of the first processing apparatus—for example a first welding robot of a welding machine.

In order to produce the synchronism of the first working step of the first processing apparatus with the second working step of the second processing apparatus, the first processing speed at the first tool can be increased or also reduced in the event of Inequality of the synchronization parameters.

The processing change in its configuration as a change in the first processing speed at the first tool of the first tool apparatus in order to produce the synchronism of the working steps of the processing apparatuses also comprises derivatives of the first processing speed (in terms of time), such as processing acceleration or processing pressure.

Furthermore, the first processing speed for the processing process of the workplece can also be configured as a processing variable in such a way that, without a movement of the first tool, the synchronism is nevertheless performed by means of, for example, a change in a material application during welding or printing of the workpiece, in that more or less welding or printing material is applied to the workpiece by means of the first tool.

In a further advantageous embodiment of the synchronization method, in the case that the second processing apparatus has a second tool apparatus having a second tool, in the event of inequality of the synchronization parameters a second processing speed or derivatives thereof, by means of which the second tool processes the workplece, is changed as a processing change.

Any change in the speed for processing the workpiece is assumed as the second processing speed and its processing change, which in this case relates to the second processing speed for the second tool—for example a second welding head—and is executed by means of the second tool apparatus of the second processing apparatus—for example a second welding robot of a welding machine.

In order to produce the synchronism for the first working step of the first processing apparatus with the second working step of the second processing apparatus, the second processing speed at the second tool can be increased or also reduced in the event of inequality of the synchronization parameters.

The processing change in its configuration as a change in the second processing speed at the second tool of the second tool apparatus in order to produce the synchronism of the working steps of the processing apparatuses also comprises derivatives of the second processing speed (in terms of time), such as processing acceleration or processing pressure.

Furthermore, the second processing speed for the processing process of the workpiece can also be configured as a processing variable in such a way that, without a movement of the second tool, the synchronism is nevertheless performed by means of, for example, the change in the material application during welding or printing of the workpiece, in that more or less welding or printing material is applied to the workpiece by means of the second tool.

In a further advantageous embodiment of the synchronization method, in the case that the second processing apparatus has a workpiece apparatus having the workpiece, in the event of inequality of the synchronization parameters a third processing speed or derivatives thereof, by means of which the workpiece apparatus moves the workpiece with respect to the first tool, is changed as a processing change.

Here, too, any change in the speed for processing the workpiece is assumed as the second processing speed and its processing change, which in this case relates to the second processing speed for the workpiece and is executed by means of the workpiece apparatus having the workpiece—here the workpiece apparatus as a receiving arrangement of the workpiece, for example for processing by means of at least one welding robot of a welding machine.

In order to produce the synchronism of the first working step of the first processing apparatus with the second working step of the second processing apparatus, the second processing speed at the workpiece apparatus with the workpiece can be increased or also reduced in the event of Inequality of the synchronization parameters.

The processing change in its configuration as a change of the third processing speed at the workpiece of the workpiece apparatus in order to produce the synchronism of the working steps of the processing apparatuses also comprises derivatives of the third processing speed (in terms of time), such as processing acceleration or processing pressure.

Furthermore, the second processing speed for the processing process of the workpiece can also be configured as a processing variable in such a way that, without a movement of the second workpiece of the workpiece apparatus, the synchronism is nevertheless performed by means of, for example, the change in the material application during welding or printing of the workpiece, in that for example more or less welding or printing material is applied to the workpiece by means of the first tool.

The processing changes by means of the processing speed in order to produce the synchronism in relation to the first processing apparatus having the first tool, the second processing apparatus having the second tool or the second processing apparatus with the workpiece advantageously allow different processing scenarios. In this case, the second processing speed of the second processing apparatus is to be applied to the second tool of the second tool apparatus or to the workpiece of the workpiece apparatus.

In a first processing scenario, only the first processing speed for the first processing apparatus is changed in the event of inequality of the synchronization parameters in order to produce the synchronism, the processing speed for the second processing apparatus remains unchanged.

In a second processing scenario, only the second processing speed for the second processing apparatus is changed in the event of inequality of the synchronization parameters in order to produce the synchronism, the processing speed for the first processing apparatus remains unchanged.

In a third processing scenario, both the first processing speed for the first processing apparatus and the second processing speed for the second processing apparatus are changed in the event of inequality of the synchronization parameters in order to produce the synchronism.

In a further advantageous embodiment of the synchronization method, the first working step is performed by means of a first subprogram and the second working step is performed by means of a second subprogram, and comprises a processing program of at least one of the subprograms for correspondingly one of the working steps and a comparison program for comparing the synchronization parameters.

Thus, the processing program can be implemented, for example, in an overarching manner in relation to the processing apparatuses by means of the one processing machine, that is to say In the case of a centralized construction, which reduces a complexity of the software topology but also the complexity of the topology of the processor units (control units) required for this.

However, the first subprogram and the comparison program can run jointly implemented in the processing program of a control unit of the first processing apparatus, wherein the second subprogram runs separately implemented in a further control unit of the second processing apparatus. This supports a decentralized construction of the two processing apparatuses, for example by means of the processing machine and the further processing machine.

In a further advantageous embodiment of the synchronization method, the comparison program is executed in one of the subprograms.

The implementation of the comparison program in one of the subprograms further advantageously reduces the complexity of the software topology for performing the working steps of respective processing apparatuses and of the comparison of the synchronization parameters.

In a further advantageous embodiment of the synchronization method, the working steps and the comparison are performed by means of a cloud application in a cloud.

By outsourcing the working steps—the subprograms—and the comparison—of the comparison program—which are implemented as a cloud application, for example in the form of the processing program in the cloud, the complexity of the required computing power (hardware and software) is advantageously reduced compared to the processing apparatuses of the processing machine or the processing machines.

In a further advantageous embodiment of the synchronization method, at least the first processing apparatus and the second processing apparatus are stored in the cloud as digital twins and are prepared for the cloud application to execute the working steps and the comparison.

By means of storing at least the processing apparatuses as digital twins in the cloud—generally also as a component of the processing machine or the processing machines—it is possible, for example, to perform a simulation for processing the workpiece using the synchronization method for the coordinated execution of the working steps. This advantageously influences the quality of the processing of the workpiece and the reduction of the throughput time under real processing conditions,

In order to achieve the object, a processing machine is furthermore proposed for processing a workpiece, comprising a first processing apparatus having a first synchronization parameter in a first working step, a second processing apparatus having a second synchronization parameter in a second working step, and a control unit for performing a comparison of the two synchronization parameters and Implementing the working steps in accordance with the synchronization method in accordance with the invention for the coordinated execution of the working steps for processing the workpiece.

Likewise in order to achieve the object, a processing machine system is proposed for processing a workpiece, comprising a first processing apparatus of a processing machine having a first synchronization parameter in a first working step, a second processing apparatus of a further processing machine having a second synchronization parameter in a second working step, and a control unit for performing a comparison of the two synchronization parameters and implementing the working steps in accordance with the synchronization method in accordance with the invention for the coordinated execution of the working steps for processing the workpiece.

Furthermore, in order to achieve the object a computer program product is proposed, which is configured for the at least partial implementation of the synchronization method in accordance with the invention.

The above-described characteristics, features and advantages of this invention and also the manner in which these are achieved become clearer and more easily understandable in conjunction with the following description of the exemplary embodiments that are further explained in conjunction with the figures. It is shown in:

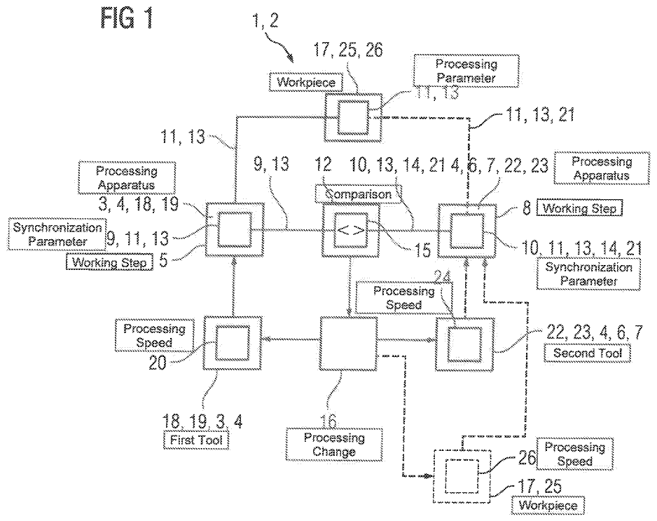

FIG. 1 a first schematic illustration of the synchronization method in accordance with the invention for the coordinated execution of working steps for processing a workpiece,

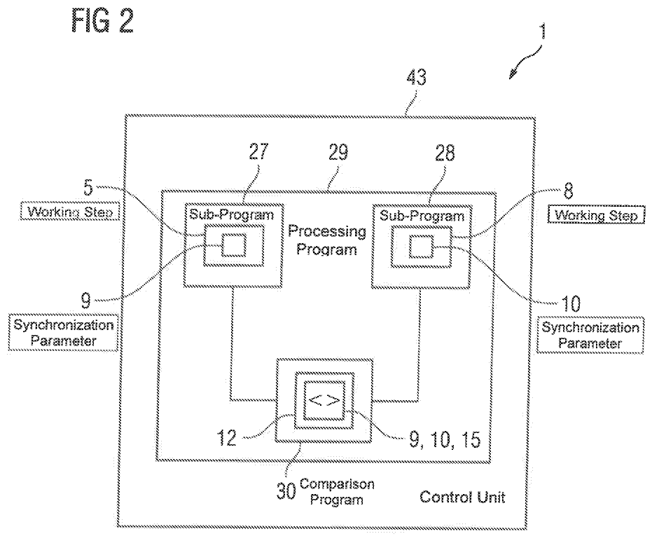

FIG. 2 a second schematic Illustration of the synchronization method in accordance with the invention in accordance with FIG. 1, executed in a control unit,

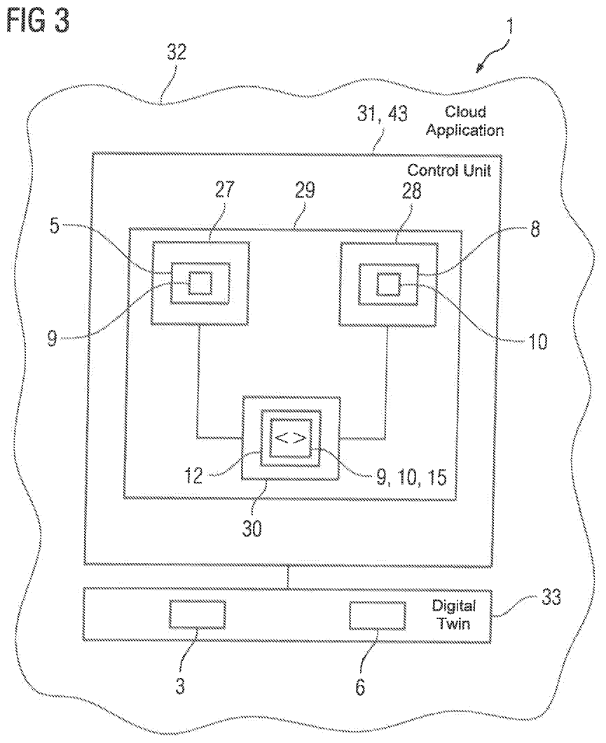

FIG. 3 a third schematic illustration of the synchronization method in accordance with the invention in accordance with FIG. 1, executed in a cloud,

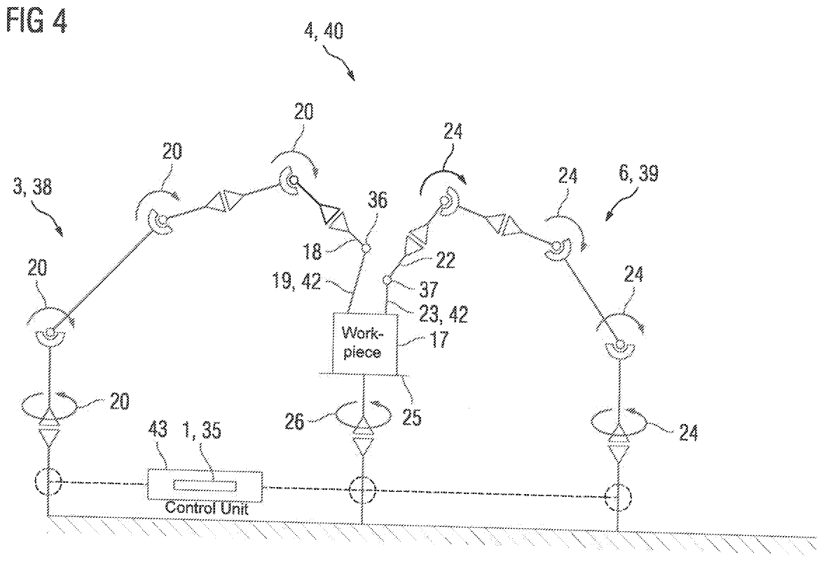

FIG. 4 a schematic illustration of a processing machine, configured as a welding machine, for implementing the synchronization method in accordance with the invention and

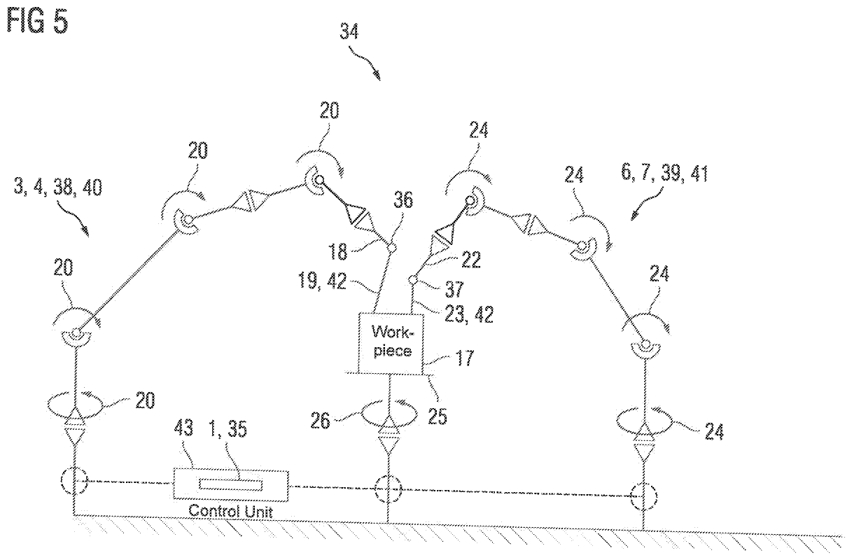

FIG. 5 a schematic illustration of a processing machine system, configured with a processing machine as a welding machine and a further processing machine as a further welding machine, for implementing the synchronization method in accordance with the invention.

FIG. 1 illustrates a schematic illustration of the synchronization method 1 in accordance with the invention for the coordinated execution 2 of working steps 5, 6 for processing a workpiece 17.

For a first processing apparatus 3 of a processing machine 4 a first working step 5 is executed. The first working step 5 includes a first synchronization parameter 9, which is based on a processing parameter 11 that is configured as a processing desired value 13.

In a second processing apparatus 6 of the processing machine 4 or of a further processing machine 7 a second working step 8 is executed. The second working step 8 includes a second synchronization parameter 10, which is based on a processing parameter 11 that is configured as a simulation desired value 14 or as a dependent processing desired value 21.

The processing apparatus 3 has a first tool apparatus 18 having a first tool 19, the second processing apparatus 6 has a second tool apparatus 22 having a second tool 23 in order to process a workpiece 17 on a workpiece apparatus 25.

The processing parameter 11 that is configured as a processing desired value 13 for the first synchronization parameter 9 in the first working step 5 corresponds, for example, to a desired value for a workpiece feed of the workpiece 17 on the workpiece apparatus 25, which is generated in the working step 5 of the first processing apparatus 3. In this exemplary embodiment, both the first tool 19 of the first tool apparatus 18 of the first processing apparatus 3 and the workpiece 17 of the workpiece apparatus 25 are subject to a movement, which is based on the desired value for the workpiece feed as a processing parameter 11.

Accordingly, a movement for the processing of the workpiece 17 by the first tool 19 of the tool apparatus 18 of the first processing apparatus 3 is coordinated with the movement of the workpiece 17 of the workplece apparatus 25.

However, the second processing apparatus 6 is also to process the workpiece 17 of the workpiece apparatus 25 synchronously with the second tool 23 of the second tool apparatus 22, in relation to the first processing apparatus 3, for the coordinated execution 2 of the working steps 5, 6.

However, the processing parameter 11 for the second synchronization parameter 10 in the second working step 8—here, by way of example, the desired value for the feed of the workpiece 17 of the workpiece apparatus 25—is not necessarily known in the second working step 8, as generated as a processing desired value 13 in the first working step 5 of the first processing apparatus 3. The first synchronization parameter 9 in the first working step 5 can deviate from the second synchronization parameter 10 of the second working step 8 during the processing of the workpiece 17.

For the second synchronization parameter 10 of the second working step 8, the processing parameter 11 that is configured as a processing desired value 13 can therefore be determined, on the one hand, as a simulation desired value 14 or as a dependent processing desired value 21.

The simulation desired value 14 can further be determined during the execution of the second working step 8 for the second synchronization parameter 10. For this purpose, a starting value is predefined for the second synchronization parameter 10, for example, at the start of the simulation.

As already described above, a primary replica model can be used for determining the dependent processing desired value 21, wherein the processing desired value 13 is used here as a primary and the dependent processing desired value 21 that is required for the second synchronization parameter 10 is used as a replica.

The first synchronization parameter 9 is continuously compared with the second synchronization parameter 10 by means of a comparison 12. If an inequality 15 is determined, a processing change 16 of different processing speeds 20, 24, 26 can be performed by means of three processing scenarios.

In a first processing scenario, in order to produce the synchronism between the two processing apparatuses 3, 6, in the event of inequality 15 of the synchronization parameters 9, 10, only a first processing speed 20 for the first tool 19 of the first tool apparatus 18 of the first processing apparatus 3 is changed as a processing change 16, the second processing speed 24 for the second processing apparatus 6 of the second tool 23 of the second tool apparatus 22 remains unchanged.

In a second processing scenario, in order to produce the synchronism between the two processing apparatuses 3, 6, in the event of inequality 15 of the synchronization parameters 9, 10, only a second processing speed 24 for the second tool 23 of the second tool apparatus 22 of the second processing apparatus 6 is changed as a processing change 16, the first processing speed 20 for the first processing apparatus 3 of the first tool 19 of the first tool apparatus 18 remains unchanged.

In a third processing scenario, in order to produce the synchronism between the two processing apparatuses 3, 6 in the event of Inequality 15 of the synchronization parameters 9, 10, both the first processing speed 20 for the first processing apparatus 3 of the first tool 19 of the first tool apparatus 18 and the second processing speed 24 for the second processing apparatus 6 of the second tool 23 of the second tool apparatus 22 are changed.

It is also conceivable for the processing apparatuses 3, 6 to be configured in such a way that the first processing apparatus 3 has the first tool 19 of the first tool apparatus 18 and the second processing apparatus 6 has the workpiece 17 of the workpiece apparatus 25. In this case, a third processing speed 26, which replaces the second processing speed 24, in particular in relation to the three processing scenarios described above, is used for the second processing apparatus 6 as a processing change 16 and is used for the second working step 8.

FIG. 2 illustrates a second schematic illustration of the synchronization method 1 in accordance with the invention on the basis of FIG. 1, wherein the synchronization method 1 is implemented in a control unit 43.

The control unit 43 accordingly comprises a processing program 29 having a first subprogram 27, a second subprogram 28 and a comparison program 30.

The first working step 5 is executed by means of the first subprogram 27, wherein the first working step 5 has the first synchronization parameter 9.

The second working step 8 is executed by means of the second subprogram 28, wherein the second working step 8 has the second synchronization parameter 10.

The comparison program 30 compares the first synchronization parameter 9 with the second synchronization parameter 10 by means of the comparison 12 for inequality 15.

The third schematic illustration, visualized by means of FIG. 3, of the synchronization method 1 in accordance with the invention in accordance with FIG. 1 illustrates the implementation of the synchronization method 1 in a cloud.

In FIG. 3, the control unit 43 is illustrated analogously to FIG. 1, but with the difference that the control unit 43 is configured as a cloud application 31 in a cloud 32.

Furthermore, the first and the second processing apparatus 3, 6 are each configured as a digital twin 33, wherein the synchronization method 1 for the coordinated execution of working steps for the processing of a workpiece in connection with the cloud application 31 can be simulated, for example.

FIG. 4 illustrates a schematic Illustration of a processing machine 4, configured as a welding machine 40, for implementing the synchronization method 1 in accordance with the invention.

In the exemplary embodiment, the processing machine 4 is designed as a welding machine 40. It comprises a first processing apparatus 3, configured as a first welding robot, a second processing apparatus 6, configured as a second welding robot 39 and a workplece apparatus 25 having a workpiece 17 to be processed, in this example for applying welding seams to the workpiece 17.

The first welding robot 38 has a first welding head 36 with welding material 42, the second welding robot 39 has a second welding head 37 with welding material 42.

The first welding head 36 with the welding material 42 form the first tool 19 of the first tool apparatus 18 of the first processing apparatus 3, and the second welding head 37 with the welding material 42 form the second tool 23 of the second tool apparatus 22 of the second processing apparatus 6.

A processing change by means of the first processing apparatus 3 with the first tool 19 of the first tool apparatus 18 can be performed by changing the first processing speed 20, and a processing change by means of the second processing apparatus 6 with the second tool 23 of the second tool apparatus 22 can be performed by changing the second processing speed 24.

In the exemplary embodiment in FIG. 4, the workpiece 17 of the workpiece apparatus 25 is processed by means of a third processing speed 26, which corresponds to the implementation of the synchronization method 1 in accordance with FIG. 1.

The synchronization method 1 is Implemented by means of a control unit 43, in this case on the basis of the computer program product 35.

FIG. 5 illustrates a schematic illustration of a processing machine system 34, configured with a processing machine 4 as a welding machine 40 and a further processing machine 7 as a further welding machine 41, for implementing the synchronization method in accordance with the invention.

The processing machine 4 of the processing machine system 34 is configured as a welding machine 40 having a first welding robot 38 (as a first processing apparatus 3), having a first welding head 36 and having welding material 42 (as a first tool 19 of a first tool apparatus 18).

The further processing machine 7 of the processing machine system 34 is configured as a further welding machine 41 having a second welding robot 39 (as a second processing apparatus 6), having a second welding head 37 and having welding material 42 (as a second tool 23 of a second tool apparatus 22).

Furthermore, the Illustration of FIG. 5 is to be viewed like that of FIG. 4, wherein the workpiece 17 of the workpiece apparatus 25 is processed by means of a third processing speed 26, which corresponds to the Implementation of the synchronization method 1 in accordance with FIG. 1.

The synchronization method 1 is implemented by means of a control unit 43, in this case on the basis of the computer program product 35, for the processing machine system 34.

1.15. (canceled)

16. A synchronization method for coordinated execution of working steps for processing a workpiece, the synchronization method comprising
executing with a first processing apparatus of a processing machine a first working step having a first synchronization parameter;
executing with a second processing apparatus of the processing machine a second working step having a second synchronization parameter;
wherein the first and second synchronization parameters are based on a processing parameter for processing the workpiece;
continuously comparing the first synchronization parameter with the second synchronization parameter; and
performing a coordinated execution of the first and second working step in dependence upon a result of the comparison.

17. The synchronization method of claim 16, wherein the first synchronization parameter is based on the processing parameter which is formed as a processing desired value,

18. The synchronization method of claim 16, wherein the second synchronization parameter is based on the processing parameter which is formed as a simulation desired value for the processing desired value, or is based on a processing parameter which is formed as a dependent processing desired value for the processing desired value.

19. The synchronization method of claim 18, further comprising determining the simulation desired value during execution of the second working step.

20. The synchronization method of claim 16, further comprising when the synchronization parameters are determined not to be equal as a result of the comparison, performing a processing change in at least one of the working steps of the processing apparatuses associated with the at least one working step.

21. The synchronization method of claim 20, wherein when the first processing apparatus includes a first tool apparatus with a first tool, the method further comprising, when the synchronization parameters are determined not to be equal, changing as the processing change a first processing speed or derivatives thereof.

22. The synchronization method of claim 21, wherein when the second processing apparatus includes a further tool apparatus with a further tool, the method further comprising, when the synchronization parameters are determined not to be equal, changing as the processing change a second processing speed or derivatives thereof, employed by the further tool to process the workpiece.

23. The synchronization method of claim 21, wherein when the second processing apparatus includes a workpiece apparatus with the workpiece, the method further comprising, when the synchronization parameters are determined not to be equal, changing as the processing change a third processing speed or derivatives thereof, which enables the workpiece apparatus to move the workpiece with respect to the first tool.

24. The synchronization method of claim 16, further comprising:
performing the first working step by means of a first subprogram and performing the second working step by means of a second subprogram, and
supplying a processing program containing at least one of the first and second subprograms for a corresponding one of the working steps and a comparison program for comparing the synchronization parameters.

25. The synchronization method of claim 24, wherein the comparison program is executed in one of the subprograms.

26. The synchronization method of claim 16, wherein the working steps and the comparison are performed by means of a cloud application in a cloud.

27. The synchronization method of claim 26, wherein the first processing apparatus of the processing machine and the second processing apparatus of the processing machine or of the further processing machine for executing the working steps and the comparison are stored In the cloud as digital twins.

28. A processing machine for processing a workpiece, the processing machine comprising
a first processing apparatus having a first synchronization parameter in a first working step,
a second processing apparatus having a second synchronization parameter in a second working step, and
a control unit designed to perform a comparison of the first and the second synchronization parameters and to implement the working steps in accordance with the synchronization method set forth in claim 16 for a coordinated execution of the first and second working steps for processing the workpiece.

29. A processing machine system for processing a workpiece, the processing machine system comprising:
a first processing apparatus of a processing machine having a first synchronization parameter in a first working step,
a second processing apparatus of a further processing machine having a second synchronization parameter in a second working step, and
a control unit configured to perform a comparison of the first and the second synchronization parameters and to implement the working steps in accordance with the synchronization method in accordance with claim 16 for a coordinated execution of the first and second working steps for processing the workpiece.

30. A computer program product, comprising a computer program stored on a non-volatile computer-readable medium, wherein the computer program includes computer instructions which, when read into a memory of a processing machine and executed by a processor of the processing machine, causes the processing machine to at least partially execute the synchronization method set forth in claim 16.
